(19) United States
(12) Patent Application Publication
(10) Pub. No.: US 2015/0257860 A1
(43) Pub. Date: Sep. 17, 2015

(54) Magnetic Denture Retention Systems with Non-Surgical, Limited Surgical, and Minimally Invasive Surgical Methods of Use

(71) Applicant: Aviva L. Andreen, New Rochelle, NY (US)

(72) Inventor: Aviva L. Andreen, New Rochelle, NY (US)

(21) Appl. No.: 14/204,534

(22) Filed: Mar. 11, 2014

(51) Int. Cl. A61C 13/235

(52) U.S. Cl. CPC A61C 13/235

(57) ABSTRACT

A denture attachment system and method for replacing natural teeth, comprising a set of dentures for one or more teeth made out of a first dental durable material, a first magnetic component secured to the set of dentures, and a second magnetic component separate from but attracted to and couplable to the first magnetic component. Preferably, the dentures are made of ceramic or acrylic, and the first magnetic component is embedded therein, and the second magnetic component is held to the patient by passing through or in the nose, nostril, a cavity in the cheek, an earlobe, lip, frenulum, palatal arch, etc. The second magnetic component is attracted to the first magnetic component (of the dentures) to hold the same in the mouth, as desired.

### FIELD OF THE INVENTION

The present invention relates to devices, components, systems and methods for magnetic retention of maxillary and/or mandibular dentures and other dental-related devices and more particularly to improved magnetically held components, methods and apparatus for individual and bridge-like prosthetic tooth/teeth replacement. Basically, the denture components and replacements (collectively referred to as “dentures”) are maintained in relative position in the mouth by magnetic coupling of the denture provided with a ferro-magnetic or magnetic material to a mating and attractive magnetic or ferro-magnetic material, located either in the periosteum of the mouth or more remotely, e.g., in the cheek, nose, jaw, sinus, or other head-based location, with the magnetic holder(s) beings so located away from the denture to be maintained within the mouth. Preferably, the location of the holding magnets for the magnetic-attractive dentures is located without extensive surgical intervention. Preferably, the magnetic holders are located up the nostrils of the nose, in the cheek, under the jaw bone, etc.

### BACKGROUND OF THE INVENTION AND DISCLOSURE

The field of dentistry has generally been unable or, at least, it is difficult to provide dentures to edentulous individuals, usually the elderly, whose palates and/or mandibular ridges have resorbed to the point that the dental impressions on which dentures are based are difficult if not impossible to make. Current techniques for the preparation of dentures have largely been unable to make impressions of resorbed edentulous maxillas and/or mandibles, whether in the elderly, wounded soldiers or other trauma victims. Furthermore, expensive bone-grafting techniques are often very difficult or nearly impossible or medically contraindicated and, where possible, are often financially prohibitive to the patient. Osteogenesis and bone growth around and integrated into implants to attach dentures is expensive and time consuming. Some recent advances in metals and ceramic magnetic technology provide possible solutions to these problems using new methods of denture attachments beyond the rare-earth magnetic attachments previously used, which, however, do not address the dental prosthetic problems of extreme bone loss. The present invention aims to address these problems and to provide a realistic and cost-effective possible solution. With an aging population expected to reach 1.3 billion in the next 30 years, these new components, systems, devices and methods of magnetic denture attachment aim to provide cost-effective relief to millions of edentulous individuals, and in many cases, they can be provided with dentures while avoiding surgery altogether or with minimally invasive surgery only.

The head of the human body has natural cavities, fleshy locations and protrusions that permit the insertion or attachment of strong magnets therein such that the corresponding attraction of another magnet or ferromagnetic material enclosed or associated with a denture can couple the two together and thereby provide locational retention of the denture. Where creation, location and retention of dentures were previously difficult if not impossible based on the issues described above, the present invention provides a potential set of devices, components, solutions, systems, and methods to provide adequate, if not totally usable dentures to those individuals. Additionally, where surgery would have otherwise been necessary for the implantation of mechanically interconnected dentures and their holding screws or posts, the present invention is intended to avoid, at least in part if not totally, the requirement for invasive, costly, and risky oral surgery usually first required for locating the holding mechanisms. Where surgery is possible and needed, and desirable for the specific patient, the magnetic mechanism used herein for attachment and location retention (magnetic material within or secured to denture with corresponding attractive magnetic material located in the gum, in a cavity of the head or a newly formed cavity/location in or around the oral region) is still considered highly advantageous. The present invention comprises an entirely new approach and solution set to the problems encountered by dentists and patients in connection with providing dentures and dental related appliances to be securely held within the oral cavity. For the first time, dentures can be secured into proper location, possibly without surgery, by use of advanced attraction between magnetic materials, whether the magnet is housed in the denture and the attractive other pole of the magnet held elsewhere or where one or the other of the attractive components are formed of ferro-magnetic material and the other component the magnet to which the ferro-magnetic material is attracted. It will be appreciated that the present invention contemplates use of the magnetic attractive capacity between north and south pole magnets and a magnetic material and a ferro-magnetic material and these two attractive components can be either the denture being held or the holding device for the same. For ease of illustration, hereinafter, the denture will be referred to as comprised of ferro-magnetic material and the holding mechanism will be the magnet but, of course, without limiting the scope of the invention the attractive aspects can be reversed in position and the use of north and south pole attractive magnets used, too. Indeed, it is also within the contemplation of the present invention that electro-magnetic attraction can be used to hold the denture in relative location in the mouth with the holding devices formed of a ferro-magnetic material wrapped in a coil of electric wire and powered by electric (preferably a small battery or dry cell) current.

There are instances where maxillary or mandibular bone has been lost due to resorption in normal aging, through disease, or through trauma. Resorption is a process where bones chemically break down and release minerals into the blood. Standard methods of dental impressions and/or use of traditional or even magnetic implants have been used to provide prosthetic teeth or dentures for chewing function and to provide a cosmetically acceptable appearance to lessen the psychological trauma of tooth loss and provide the patient with an ability to smile and socialize. The ability to socialize is psychologically more important than the chewing function in dentally disabled patients as it is seemingly more critical to the patient's lifespan.

The normal structure of the face includes naturally occurring orifices which, previously, have not been used in connection with retention of dentures. These orifices comprise, for example, the nostrils of the nose, the depths of the vestibles, protrusions such as the ears or fleshy locations, as the cheeks, and even unseen cavities such as the nasal sinuses; any of which can be used with the aide of strong magnetic attractive materials to create a magnetic field that can retain a denture which contains either an opposing pole of the magnet, or, a ferromagnetic material. The magnets can either be permanently secured to the cavities or can be entirely removable from the face so that the magnets and dentures can be easily removed at night. This can be highly advantageous as it allows the dentures to be easily cleaned on a daily basis and the magnet can be replaced if need be. The magnet retainers for the dentures can be provided with a removable support device to aide in the placement, retention and removal of the dental prosthesis.

In one embodiment, the magnetic retainer and attractive component can be affixed to the face, by means of implantation in the jawline or sinuses or even by means of a piercing, so that the magnet does not fall off or impede use of the face or mouth. By implantation or fixation of the magnet to the face, a user can ensure that the dentures will remain magnetically secured in the mouth for use while simultaneously avoiding the aesthetic effect of a magnet on the exterior of the face. Often, of course, the magnetic attractor will “pull” the dentures into their mechanical sockets or physical location holding apertures in the gum and hold the same in position. Placement under the jawline can hold a lower denture by magnetic attraction directly through tissues such as the jawbone and periosteum. Through this embodiment of the present invention, a set of dentures remains easily removable should the user wish to take them out to sleep or at any other time. Use of a magnet in connection with a body piercing allows a user to maintain the magnet near their mouth while avoiding surgical implantation of the same and may even add to a fashion statement.

In an alternate embodiment, it is envisioned that a user not wishing to implant a magnet underneath the skin or in the jawline of their face, and not wishing to exhibit a piercing on their nose, lip or other facial orifice, can alternatively “wear” the magnet on the outside of their face around their gum region to magnetically attach to an opposed-polarity magnet secured to a set of dentures placed in the mouth of and worn by a user. While the use of a magnet externally on the face may not be the most aesthetically pleasing option (of course the magnet can be colored and “made up” to conceal the same) it provides the availability of dentures for an individual who cannot obtain traditional dentures but who, for one reason or another, opts out of a surgical implantation.

It is envisioned in preferred embodiments of the present invention that the magnets used in the present invention can be implanted under the skin or in the jawline of a user's face, placed into an orifice in the face such as the nostrils, affixed into the depth of the vestibles within the cheek, incorporated in a piercing on the user's face, or secured by any other means which may affix a magnet, permanently or temporarily, to a user's face. Thus, a set of dentures containing opposed-polarity magnets or attractive ferro-magnetic material for magnetic attraction between the holding magnet and the denture are adapted to be maintained in the user's mouth at a desired location for use. Alternatively, in another embodiment, a magnet can be releasably held to the outside of a user's face (by an internally located magnet, whether within the mouth or sewn into the vesitble of the cheek) to hold a set of dentures with opposed-polarity magnets in the mouth, when a user desires to have dentures but does not want to, or is unable to, have surgery to implant the magnet within their facial bones.

Independent of the location of the magnet affixed or secured to the face of a user, a second magnet with opposing polarity as the first magnet or piece of ferromagnetic metal material can be used to affix a set of dentures. It is the magnetic attraction of the first and second magnets which are adapted to hold the dentures in place in the mouth of a user where they would not otherwise be able to be held, for the reasons described above. In one embodiment the entire set of dentures—or the upper or lower palate (maxillary or mandible region, respectively) attached to the set of newly-made teeth—can be made of a magnetic, metallic material. In another embodiment, the dentures can be made of ceramic, acrylic, or other material with a magnet encased in the palatal arch base or the acrylic or ceramic gums. Either way, the attraction of the magnets allows the present invention to be used for individuals who are entirely edentulous or those who are partially edentulous, and can be utilized for replacement of either the top or bottom set of teeth or individual teeth or a plurality of adjacent teeth.

### DESCRIPTION OF PRIOR ART

There have been prior attempts at inclusion of high strength ‘rare-earth’ magnets in implant-retained or magnetic, endodontically-retained denture systems. These systems have not gained popularity, whether through lack of knowledge by the dental practitioners, lack of marketing or cost of production. Specifically, the following US and foreign patents relate to prior art systems and methods used in efforts to provide dentures for edentulous individuals: U.S. Pat. No. 4,693,686; U.S. Pat. No. 5,954,505; U.S. Pat. No. 4,431,419; U.S. Pat. No. 4,824,371; U.S. Pat. No. 6,540,515; EP0347510; U.S. Pat. No. 5,426,763; U.S. Pat. No. 2,678,228; U.S. Pat. No. 6,530,953; U.S. Pat. No. 6,033,437; WO2007079055; U.S. Pat. No. 3,646,676; U.S. Pat. No. 8,475,167; U.S. Pat. No. 7,609,061; U.S. Pat. No. 5,895,189; and U.S. Pat. No. 2,678,228.

However, none of these prior art systems or devices address the situation of an edentulous patient whose bone loss or other medical condition, or even the cost, prohibits implantation of traditional man-made dentures. Thus, the present invention is designed to overcome this problem and is specifically thought to be highly useful for patients who need dentures but cannot otherwise obtain them, and is preferably applicable with some design modifications and/or additions to provide dentures “off-the-shelf” at relatively low cost to an edentulous patient.

To Applicant's knowledge there are no denture retention systems which use orifices in the oral cavity area, separate from the gums, to hold the dentures in place. The present invention, in various embodiments, provides such a system to great advantage to many otherwise edentulous patients.

### SUMMARY OF THE INVENTION

The present invention discloses a set of components and a system and method for denture location, retention, securement and attachment. It is a set of components and a system and method for replacing natural teeth (one or more) basically comprising a set of dentures for one or more teeth made out of a first material (preferably ceramic or acrylic) for location at the maxillary or mandible region which are held in place by, for example, having a first magnetic component housed, secured or otherwise associated with the set of dentures, and a second magnetic pole or ferro-magnetic material, separate from but adapted in polarity to attract and couple to the first magnetic component and located nearby but remote from the patient's gum(s). Preferably, the dentures are made of ceramic or acrylic, and comprise the first magnetic component embedded therein, but it is envisioned that the dentures themselves could be metallic (ferro-magnetic) or even formed of one pole of a magnetic material. The second and attracting/retaining/holding and locating ferro-magnetic material or opposite pole of the magnet of the denture can either be surgically implanted in, secured to, or releasably placed externally on the face of a user (separate from the gums) wherein the second magnet's polarity or the ferro-magnetic capacity of the attracting/retaining/holding and locating device is adapted to attract the first magnetic component of the dentures to hold the same in place in the mouth. It is envisioned that the second component be proximal to the dentures and hold the same in place. This would be accomplished by locating the second component, i.e., the attracting/retaining/holding device in an orifice on the face, such as within a nostril, sewn into the flesh of the vestibule of the cheek, or it can be attached to the face by means of a facial piercing such as through the bone of the nose or flesh of a nostril, through a lip, may be even on the surface or below the surface of the cheek, implanted within the sinuses or jawline for permanent placement therein. The present invention provides a means for holding and maintaining a set of dentures in a patient whose bone resorption would not otherwise allow for a denture mold to be created and held in their mouths and as a consequence of other medical/dental issues with conventional denture retention.

### BRIEF DESCRIPTION OF THE DRAWINGS

FIG. 1A is a front elevational view of a first embodiment of the present invention, showing a first upper and lower magnet placed within maxillary and mandibular dentures, and showing a second upper magnetic component placed within the nostrils of a user for holding the maxilla and a separate, second lower magnetic component (attractive to the magnet within the lower set of dentures) secured by magnetic attraction beneath the jawline or the mandible of the user;

FIG. 1B is a front elevational view of the embodiment of the present invention substantially as shown in FIG. 1A, showing the use of two second upper magnetic components, one placed within each of the user's nostrils, and wherein the two are connected by a simple connector piece for ease of placement and removal thereof;

FIG. 1C is a front elevational view of the embodiment of the present invention substantially as shown in FIG. 1B, showing the upper magnetic components secured by resilience of wires securable to the outside of the nostrils to hold the same in place and with two separate upper denture elements, for the upper oral cavity and a single set of dentures for the lower dentures;

FIG. 2A through 2F are various embodiments of the magnetic attachment device for use in holding denture(s) in the lower portion of the patient's mouth, the cross-sectional configuration being adapted to match and coordinate with the dentures to be held and also consistent with the patient's mouth shape and the desire by the patient for having the holding and retaining component visible or not as visible—the second or retaining and holding component can be within the mandible or located below the chin of the patient;

FIG. 3A is a front elevational view of a second embodiment of the present invention as if it were located in a patient's mouth, looking face on, showing the second retaining and attracting magnetic component comprised of a pair of magnets which slide up and into the nostrils of the patient, held there by a holding pin going from one nostril component to the other, and holding the upper dentures while the lower dentures are held by another second attracting and retaining component—in this case the magnetic component is on the inside lip of the patient, held in position by a lower magnetic component secured to the mouth and cheeks of a user by means of lip piercing components which thus provide the magnetic attraction to the dentures as the second components are within the oral cavity of the patient;

FIG. 3B is a front elevational view of the embodiment of the present invention substantially as shown in FIG. 3B, and also showing the connection of the second upper magnetic component to the face of a user by means of dual nostril piercing components, with the magnetic components within the nostril but held there by nose piercings;

FIG. 3C is a front elevational view of the embodiment of the present invention basically as shown in the prior Figures but now also showing the connection of the second upper magnetic component to the face of a user by means of a lower lip piercing and the upper dentures held in place by cheek piercing which hold the second retaining and attracting components within the oral cavity of the patient, magnetically holding the upper dentures in place;

FIG. 4A is a front elevational view of another embodiment of the present invention, showing the second upper and lower magnetic components as implanted within the nose and cheeks of the user, where the second lower magnetic component is U-shaped, passing through tissue and then around the mandible of a user (or a stable can also be used) and the upper retaining and attracting component for the upper denture passes through the floor of the nose to the palate;

FIG. 4B is a front elevational view of the embodiment invention, similar to the other embodiments, but showing the second upper magnetic component (for retaining and attracting the upper denture) being a set of magnets (or ferro-magnetic material if the dentures are magnetic) and placed within the floor of the sinuses;

FIG. 4C is a front elevational view of another embodiment of the invention, showing the second upper magnetic component as placed through the floor of the sinus or palate and under the palatal tissue of a user's mouth;

FIG. 5A is a top plan view of the upper palatal component of upper dentures disclosed by the present invention, where the upper palatal component is made of a magnetic, metallic material;

FIG. 5B is a top perspective view of the upper palatal component shown in FIG. 4A, showing a set of false teeth made entirely of magnetic-attractive material embedded in ceramic or porcelain and secured to the upper palatal component by a palatal-located second magnetic-attracting and retaining component;

FIG. 5C is a top perspective view of the upper palatal component and teeth, wherein the upper palatal component and teeth are formed with a palatal arch and a magnet or ferro-magentic material is formed in the arch and the second component is held to the roof of the patient's mouth, formed of the other pole of the magnet used in the palatal arch or a ferro-magnetic material to be attracted to the arch with a magnet;

FIG. 5D is a top perspective view of an alternative configuration of the dentures disclosed by the present invention, comprising a U-shape of artificial gums and extending around the maxillary and mandibular ridges of a user's mouth wherein the dentures themselves are made of a metallic, magnetic attractive material and held by the second component secured within the mouth, between the inside of the cheek and the gum line or by second components secured by cheek piercing components;

FIG. 5E is a top perspective view of the dentures substantially as shown in FIG. 4D, wherein the dentures are made of a ceramic, acrylic, or other non-magnetic material, and comprising a first set of magnets attached thereto and to be held in place by a second set of magnetic components held by the cavities of the patient, proximal the mouth, in accordance with the other embodiments;

FIG. 5F illustrates the use of the present invention through magnetic dental prosthetics for partially edentulous patents;

FIG. 6 is a top and front perspective view of a first device configured to assist in the location and retention of the dentures, themselves made with ferro-magnetic material integrated therein, and the device being intended to be used by the patient or a nursing health care practitioner—the device being an elongated handle for a hand and having an embedded magnet or ferro-magnetic material intended to be coupled by magnetic flux to the dentures within the patient's mouth and held in location by the magnetic attraction between handle's magnet or ferro-magnetic material and the magnet or ferro-magnetic material within the denture of the patient;

FIG. 7 is front and top elevational view of a second device configured to assist in the placement of the dentures by a Dentist, and shows a handle for the Dentist's hand, an electric cord for creating an electromagnetic attraction in the head of the handle, all to assist the Dentist in the placement of the dentures described by the present invention. This device will be useful in guiding a retaining and attractive second component magnet desired to be placed in the mouth of a user for its use in holding and retaining the dentures;

FIG. 8 is a device to re-magnetize the magnetic components used in the other embodiments, comprising an external housing and a platform for securing, during remagnetization, of the other components, whether they be dentures, second holding and retaining components, or the devices used (FIGS. 6 and 7) for placement of the magnetic or ferro-magnetic components;

FIGS. 9(A)-(H) are schematic views of various shapes of the magnets which are envisioned to be embedded into the bone, the magnets being encased in bio-compatible material (e.g., Titanium)—these can be embedded into bone in or around the jaw and serve to hold the dentures in place. These can also be ceramic-metallic implants.

FIGS. 10(A)-(H) are front elevational views of various shapes of osseointegrated magnetic implants envisioned by the present invention;

FIG. 11 is a front elevational view of an additional aspect of the present invention, showing an electromagnetic denture location and retention/control mechanism adapted to be worn in a pocket of a user's shirt or on a user's belt and for the purpose of holding in position the magnetically attractive dentures of the patient;

FIG. 12 is a side perspective view of an additional embodiment of the electromagnetic denture control mechanism, adapted to be worn as an earpiece, like a headphone, up and over a user's ear;

FIG. 13 is a side perspective view of an electromagnetic chip adapted to be placed proximal to the magnetic-attracted dentures of the present invention wherein the magnetic pole opposite that of the chip is within the electromagnetic denture or the denture contains ferro-magnetic material, controlled in attraction by the integrated circuit chip;

FIG. 14 is a front perspective view of an additional embodiment of the present invention, showing a second magnetic component adapted for holding the magnetic-attractive dentures wherein the second component is preferably secured to the bottom rim or ears of a pair of glasses to be worn by a user;

FIG. 15A is a side elevational view of another embodiment of the present invention, showing the placement of the second magnetic component on an extra-oral attachment intended to be worn as an earring and suspended from and around the ear of a user;

FIG. 15B is a side elevational view of an alternate embodiment of the present invention shown in FIG. 15A;

FIG. 15C is a side elevational view of another embodiment of the present invention, showing bilateral placement of a second upper magnetic component and a second lower magnetic component on an extra-oral attachment around the ear of a user;

FIG. 15D is a side elevational view of another embodiment of the present invention, showing placement of a magnetic second component in the form of an ear piercing through the cartilage of a user's ear;

FIG. 15E is a side elevational view of another embodiment of the present invention shown in FIG. 15D, showing the placement of a magnetic second component for retaining and attracting the magnetically attracting dentures by use of an ear piercing through an ear lobe;

FIG. 15F is a side elevational view of another embodiment of the present invention to that shown in FIGS. 15D and 15E, and showing bilateral placement of a magnetic second component in the form of an ear piercing on an ear lobe and ear cartilage; and

FIG. 16 is a front elevational view of another embodiment of the present invention, showing placement of a magnetic second component in the form of a wrap around strap for the user's head much like a set of lightweight headphones, all to the advantage of magnetically attracting and holding the dentures in the patient's mouth.

### DETAILED DESCRIPTION OF THE DRAWINGS AND THE PREFERRED EMBODIMENT

Description will now be given of the invention with reference to the attached FIGS. 1-16 which should be considered along with the Brief Description of the Drawings. It should be understood that these figures are exemplary in nature and in no way serve to limit the scope of the invention as the invention will be defined by the claims, as interpreted by the Courts in an issued US patent.

The present invention discloses a set of components, a system, and a method for providing and retaining in the mouth artificial dentures. The components, system and method are intended to allow for placement, and selective removal of the dentures within the mouth. More specifically, the present invention relates to the use of magnetic attraction between artificial tooth (teeth) or complete dentures and corresponding magnetically attractive and location retaining components located near to but apart from the dentures. Preferably, the dentures are formed with magnets contained or integrated therein or at least are formed from or with ferro-magnetic material (i.e., metallic compositions which are attracted by magnets). Preferably, the retainers of the location and position of the dentures are magnets of opposite polarity to that of the artificial dentures or are made of ferro-magnetic material to be attracted to the dentures. Where a tooth, two or more adjacent teeth, a set of dentures, and/or upper and/or lower dentures or bridges, etc. are sought to be located within the patient's mouth, the retainers of the same in the position and orientation are located proximal yet separated from the dentures and the gums. As an example, a complete set of upper dentures can be secured to the palatal roof of the mouth with the magnetic or ferro-magnetic retainers located in the nostrils of the patient's nose. Alternatively, for example, if a set of lower dentures are to be selectively installed and removed, then a set of retainer components, made of magnets or ferro-magnetic material can be sewn into and placed within fleshy cheeks of the patient. Whether for replacement of a tooth, a set of teeth, the entire upper teeth or lower teeth or both, the present invention provides a mechanism, the power of magnets, to hold the same in the mouth, even if for a partially or totally edentulous user.

The upper dentures are adapted to have integrated therein and thus comprise a first upper magnet 20 and the lower dentures are adapted to have integrated therein and thus comprise a first lower magnet 22. It is within the scope of the present invention for the dentures to have a first upper and first lower magnet 20 and 22 secured to or embedded in the dentures which are likely made of another material, such as ceramic or acrylic. Alternatively, the dentures themselves are magnetic and metallic (ferro-magnetic) or formed of or with a single magnetic pole and thus act as the first upper and lower dentures with magnets 20 and 22. The dentures, of course, are properly shaped, sized and formed for the tooth(teeth) they are intended to replace.

As can be seen in FIGS. 1A, 1B, and 1C, the upper and lower dentures or teeth are secured within a mouth by the magnetic attraction between the first upper and first lower magnets 20 and 22, respectively, integrated into or secured to the dentures and the second upper and lower magnets 24 and 26, secured proximal yet spaced from the dentures and the gums. These second upper and lower magnets, when secured within an orifice, for example, will temporarily (until manually removed) hold the dentures in place, a consequence of the magnetic attraction (strength, size and shape of the magnets and/or the use of ferro-magnetic material) between the first upper and first lower magnets 20 and 22, respectively, and the second upper and second lower magnetic components 24 and 26, respectively (in the case of a complete set of upper and lower dentures). The second upper and lower magnets 24 and 26 locate, retain, and position the dentures, themselves provided with the first upper and lower magnets 20 and 22, within the mouth of the patient by second magnetic component 24 and second magnetic component 26 magnetically attracting and holding in place the first upper magnet 20 and the lower, first magnet 22 in place. The upper second magnet 24 can be shaped and sized to be placed within the nostrils of a user's nose, thus providing a natural orifice to hold the second upper magnetic component 24 in place. It is envisioned that second upper magnetic component 24 can be placed in one or both of a user's nostrils. As seen in FIGS. 1B and 1C, where second upper magnetic component 24 is placed within both nostrils, the two-component, second upper magnetic components 24 can be connected by a connector 25 (small piece of metal or rubber extending below the nose but between the nostrils) or releasably secured by individual retainers 27 which are resilient and extend from a metallic piece within the nostril to outside of the nose, clipping against the skin of the nose, like a nose clip for a swimmer. Second upper magnetic component 24 is adapted to comprise the opposite polarity as first upper magnet 20 (secured to or integrated into the upper denture) for securement of upper dentures within the mouth of the user or one of the components, denture or second upper magnetic component 24 is made of a magnet and the other is made with ferro-magnetic material. These embodiments cause the retainer or second magnetic component 24 to hold the denture, having the first magnetic component 20 integrated into or secured to the denture for the upper.

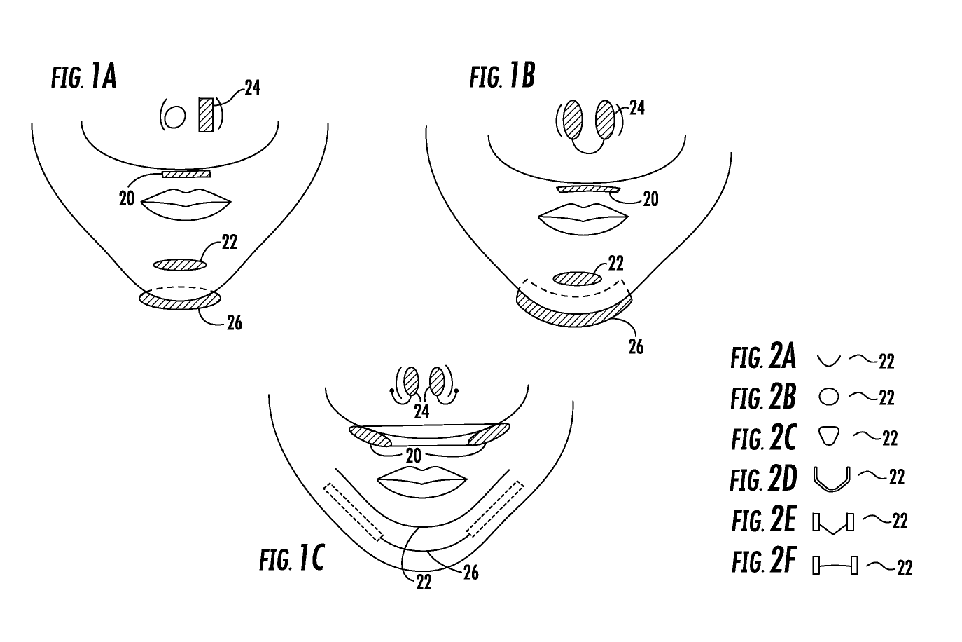

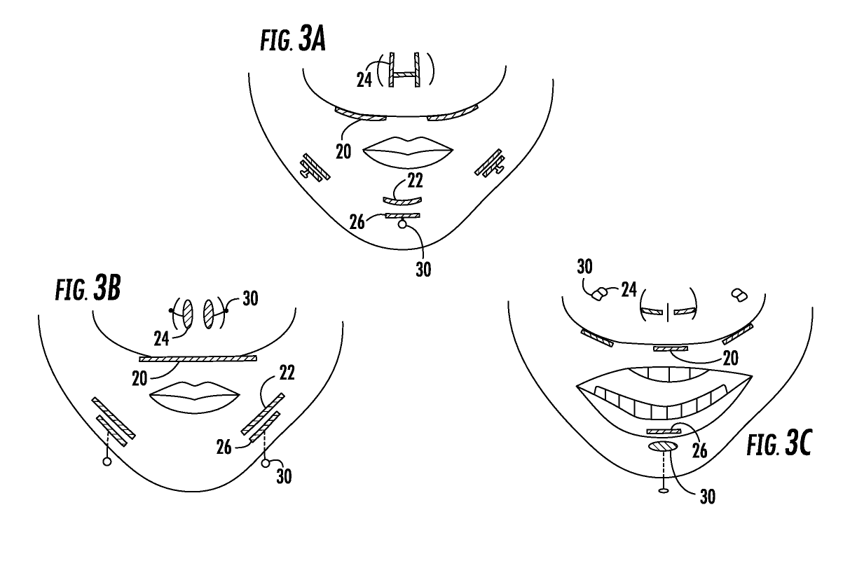

Like the first upper magnet 20 (secured to or integrated into the upper dentures), first lower magnet 22 is adapted to be held within the mouth of a user by connection to second lower magnetic component 26. In the embodiments shown in FIGS. 1A, 1B, and 1C, the second lower magnetic component 26 is adapted to be implanted under the jawline of a user for permanent securement therein. Second lower magnetic component 26 is adapted to comprise an opposite polarity magnet as first lower magnet 22, thus allowing a user to place a lower set of dentures comprising first lower magnet 22 within the mouth, and releasably secure the same to the mouth during use. Alternatively, as mentioned, one or the other of the first or second lower magnet can be the magnet and the other component a ferro-magnetic material. In the embodiments shown in FIGS. 2A-2F, the second lower magnet 26 is configured to be placed under the chin of a user, by adhesive, surgery, or a consequence of the magnetic attraction between the first and second magnets 22 and 26, with the first magnetic 22 being within the mouth and the second magnetic retainer 26 on the outside of the mouth. Various shape configurations of first lower magnets 22 can be seen in FIGS. 2A through 2F.

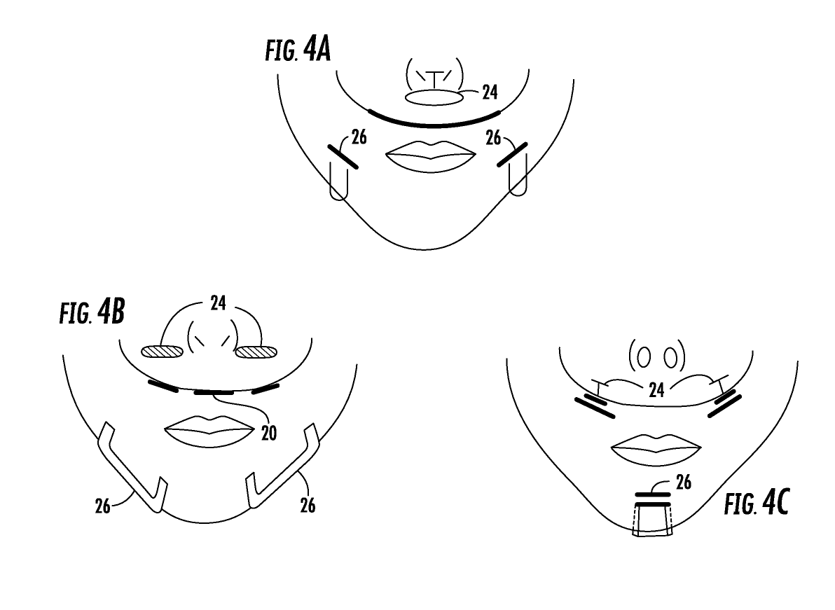

In the embodiments shown in FIGS. 3A, 3B, and 3C, second upper and lower magnetic components 24 and 26 are adapted to comprise a body piercing 30 which can hold the magnetic components within the oral cavity or to hold the second upper and/or lower magnetic components adjacent to and on the surface of the patient's outer skin. So, a second and lower magnet 26, for example, in FIG. 3A, is provided as a bulbous portion 31, small through the lip connector element 33 and the second magnetic component 26, which will couple to the first lower in the lower denture. The bulbous portion 31 extends outside of the lip, the connector 33 passes through the lip and the second magnetic component 26 will be located on the inside of the patient's lip, to hold in place the lower dentures by magnetically attracting and securing the first lower magnet 22.

Alternatively, this type of second magnet 30 can pass through the lips, cheeks, or floor of the mouth of a user, to hold second lower magnetic component 26 in place without requiring surgical implantation of the same. Piercing 30 can be placed through the lips, cheeks, or mouth of a user and then removed when desired, such as for a relaxing sleep, and then reattached to the user's face when desired. The exterior end of the connector 33 can be provided with small screw threads which are adapted to be matingly received by internal screw threads of the bulbous portion 31 so that the second (in this case lower) magnet can be removed and replaced, as desired, all to hold first lower magnet 22 in place (and thus the dentures in place by magnetic coupling).

Alternatively, as seen in FIGS. 4A, 4B, and 4C, second upper magnetic component 24 can be surgically implanted within a user's sinuses or under the tissue of the palatal arch for permanent securement of the same in the user's face. The second lower magnetic component 26 can be implanted within the mandible of a user. This embodiment allows a fully edentulous patient to maintain a top and bottom set of dentures without any external devices or placement of the magnetic components within any orifices of the user's face. The first and second magnetic components 220, 22 and 24 and 26, can be single pieces or multiple magnetic or ferro-magnetic pieces depending upon shape, weight, strength, size, etc. of the dentures, the patient's mouth, orifices, face, etc.

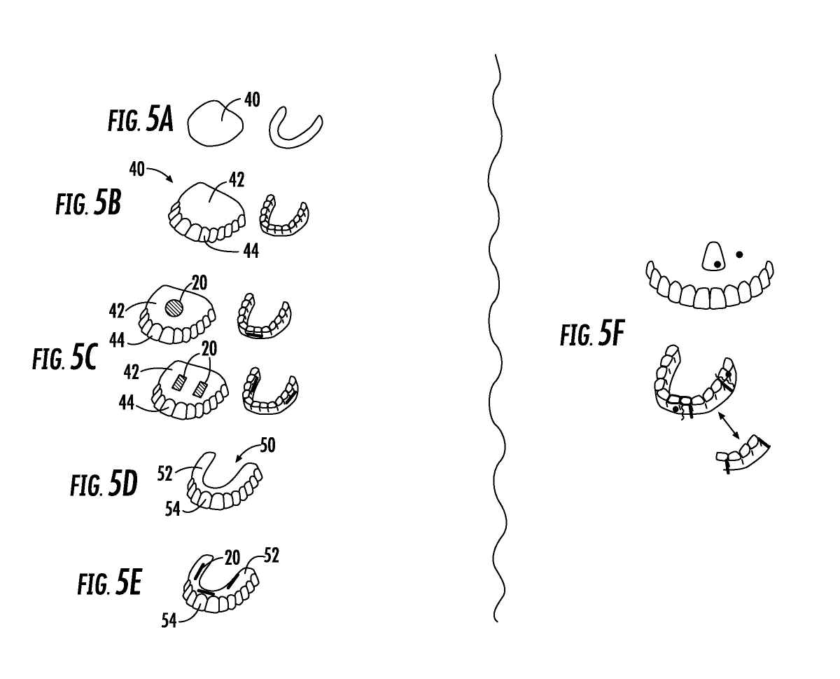

The dentures disclosed by the present invention are intended to be preferably made of acrylic, ceramic, or other material, and comprise a magnet embedded therein or secured thereto, or are adapted to be made entirely of a metallic and ferro-magnetic material. As seen in FIG. 5A-5C, upper dentures 40 formed with the upper palatal component 42 can be ferro-magnetic or formed of or with a magnet, or can comprise first upper magnet 20 embedded therein. Additionally, as seen in FIG. 5B, upper dentures 42, including teeth component 44, can be made out of a metallic and ferro-magnetic material. In FIG. 5C, first upper magnet 20 is placed within the upper denture 40, which themselves are made of ceramic or acrylic. That upper denture 40 is adapted to magnetically be secured in place by its attraction to second upper magnetic component 24, which is secured to or releasably attached to the user's mouth as shown in the FIGS., and thus hold the upper dentures 40 in place. It could, of course, as shown in the other embodiments, be held by second magnetic component 24 which is placed in the user's nostrils, through the lip, cheeks, etc.

In an alternate embodiment, shown in FIGS. 5D and 5E, upper dentures 50 can be configured in a somewhat traditional horseshoe configuration which wrap around the maxillary and mandibular ridges of a user's mouth without using an entire upper palatal component. Thus, the palatal component 52 and/or teeth component 54 of the upper dentures 50 can be made of a magnetic or ferro-magnetic material, or can be made of acrylic or ceramic or other non-metallic material and comprise a first upper magnet 20 attached to or integrated therein. It is envisioned that all of the embodiments discussed for the upper dentures including the various shapes of the upper dentures 40 and 50 and the placement of first upper magnet 20 are adapted to be used for lower dentures as well. Additionally, it is envisioned that in any of these embodiments, the upper dentures 40 or 50 can be securely held to the roof of the user's mouth and magnetically attracted to second upper magnetic component 24 whether the dentures themselves are made of a magnetic, metallic material, or they are made of ceramic, acrylic, or another material and comprise a first upper magnet 20 embedded therein or secured thereto.

In any configuration of the upper or lower dentures, upper and lower first magnets 20 and 22 are adapted to magnetically attract to and be secured/retained in position by second upper magnetic component 24 and second lower magnetic component 26 to thereby secure a set of dentures within the mouth of a fully or partially edentulous user. Thus, the present invention is intended to secure magnets to an orifice, fleshy part, or to the face of a user where resorption of the maxillary or mandibular regions would otherwise prohibit or make difficult the securement of dentures. In certain embodiments, the second upper and lower magnetic components 24 and 26 are adapted to be secured to the outside of the face or in an orifice thereof without requiring surgical implantation of the same, and in other embodiments the second upper and lower magnetic components 24 and 26 are adapted to be implanted within the sinuses, under the jawline, in the cheek, through a lip, bone, cartilage, or under the skin of a user's mouth for permanent placement and securement of the magnets therein. In a further embodiment, shown in FIG. 5F, magnetic prosthetic teeth may be used for partially edentulous individuals. Shown there, lower first magnet 22 is integrated into the prosthetic teeth.

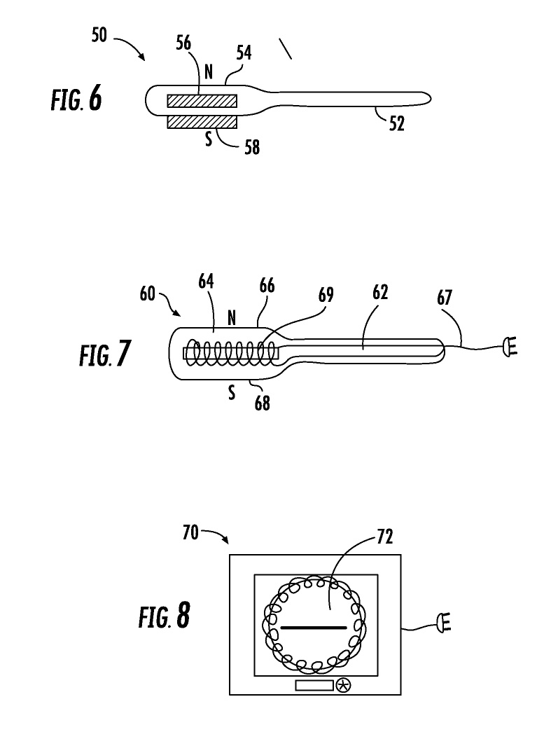

Also disclosed by the present invention is the use of tools adapted to aid in the placement of the magnetic components of the present invention in the mouth of a user. FIG. 6 discloses one such tool 50, comprising a non-magnetic handle 52 with a magnetic head 54 comprising a magnet held in the head and extending from the head's top side 56 to its underside 58. Thus, the magnet can attract a second magnetic component of either opposite polarity to the embedded magnet or can attract and hold a second component 24 or 26 if made of ferro-magnetic material. This handle 50 aids the dentist and or the patient or nursing care provider in placing and removing the dentures, themselves having the first magnetic components.

FIG. 7 discloses another such tool 60 comprising a handle 62 and a head 64 with two sides 66 and 68. This tool 60 has an electromagnet 69 encased in head 64, and further comprises a cord 67 which is adapted to be plugged into an electrical outlet to power the electromagnet 69. This tool, too, can be used for placement, retention, and removal of the dentures which are provided with the second magnetic component, 24 and/or 26.

Disclosed in FIG. 8 is a tool 70 which comprises a platform 72 adapted to remagnetize magnets, either the first or second magnetic components (or both). This device provides a simple electromagnetic component which, when the first or second magnetic components are placed thereon or proximal thereto, will remagnetize the attractive force of the magnet(s), whether integrated into or attached to the dentures or even if the magnets are the second magnetic components 24 and 26.

FIGS. 9A-9H disclose multiple shapes of magnets envisioned by the present invention and adapted to be implanted within the bone of the face of a user so as to best conform to the shape of the surface in which it is implanted. These magnetic implants have a magnetic core inside of a bio-compatible material, for example, titanium. FIGS. 9A through 9C, are three standard shapes, namely, a dime-like or short cylinder, a long axis cylinder, and a parallelepiped shape, respectively. Within each is the magnet for attracting and holding the magnet 20 or 22 of the denture, i.e., the denture is supplied with its magnet or formed with ferro-magnetic material. Each shape is formed from a bio-compatible material and the magnet is contained therein with the wall of the “shape” being thin enough that the lines of flux of the magnet pass through to attract to and hold the first magnetic component, whether 20 or 22.

FIGS. 9D through 9G show various other shapes for the second magnetic component with a magnet held therein. The shapes allow the second magnetic component 24 or 26 to be placed within cavities, within bone, cheek, etc. The shapes are provided (in this embodiment) with bi-polar magnets which are adapted to attract and hold in position the upper or lower first magnetic components 20 and 22, within the mouth by conventional N-S magnetic coupling.

FIGS. 10A-10H disclose multiple shapes of osseointegrated magnetic implants envisioned for use with the present invention. While certain shapes are disclosed, the present invention is not limited to those shapes and configurations specifically shown herein. Here, too, the implants contain magnetic components, the second magnetic components 24 or 26. The implants are adapted to be screwed into (by their exterior screw threads) the bone of the jaw of the patient. The component which is embedded into the jaw is biocompatible material. Extending upwardly (in the case of the lower second magnetic component for securing and retaining the lower denture via magnetic attraction to component 22, is a disc-like magnet. The top surface of the simple screw implants shown in FIGS. 10A through 10C are flat headed magnets. The other implants project upwardly with magnetic components which will serve to secure the first lower magnetic component 22, embedded into or integrated with the lower denture.

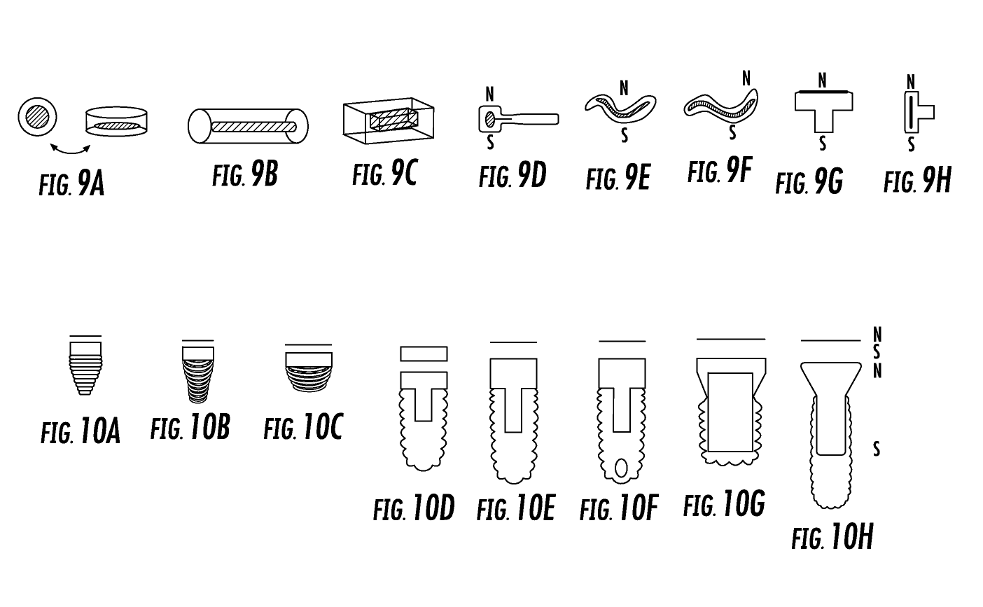

The present invention is also adapted to comprise a controller 80 which can be worn in the pocket of a user's shirt, on a user's belt, or even around a user's ear like a hands-free electronic accessory. These are generally shown in FIGS. 11 and 12. The controller, an electromagnetic induction device 80 can be used to increase or decrease the strength of the magnets used by the present invention. For example, the magnetization can be decreased when a user wishes to remove the dentures to go to sleep, and the magnetization can be increased when the user needs to increase security of the magnets, such as if they plan to eat a food which requires a lot of chewing. The controller 80 comprises a control, an induction loop, a source of power and a processor chip 90 which is adapted to send electromagnetic signals to nearby magnets (first and/or second) used in the present invention for retaining and allowing removal of dentures.

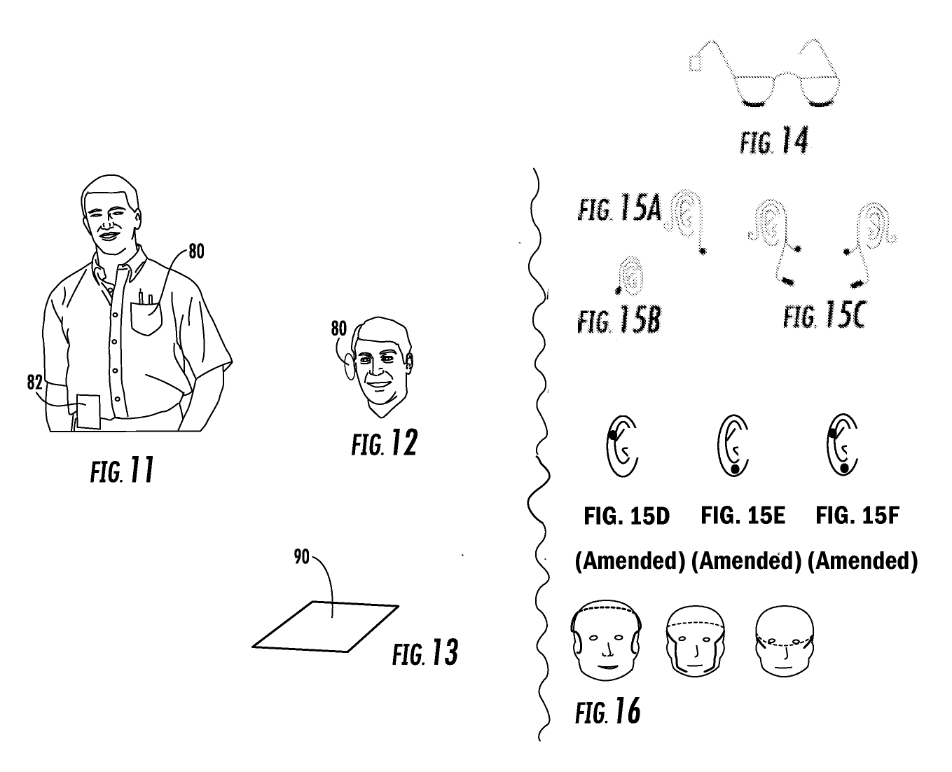

FIG. 14 shows a pair of spectacles with magnets (the second magnet 26, in two parts) secured within the lower portion of the frames. FIG. 15A shows an ear dangling second magnetic component which is adapted to drape over the ear for securing it to the wearer's face and then provide a downwardly drooping magnet, second magnetic component 24, like a long earring, extending near to the first magnetic component 20, with the second magnetic component on the outside of the wearer's face and the first magnetic component on the inside of the mouth, integrated to or secured to the upper denture. FIGS. 15C through 15F show other forms of earrings and articles of jewelry for securing the second magnetic component near to the face, consistent with the present invention.

FIG. 16 shows the use of a conventional set of headphones, wrapping around the top or back of the head, over the ears for support, and provided with a set of second magnetic components for attracting and retaining the first magnetic components of the dentures.

While the preferred embodiments discussed herein provide the second magnetic components on or within the face of a user, it is also envisioned that the second magnetic component can be secured to the bottom rim or the temple pieces or the ear engaging sections of a pair of glasses, on an ear piercing in the lobe or cartilage (or both) of a user, or even on a head strap, as seen in FIGS. 14, 15A-F, and 16, respectively. In these embodiments, the magnetic attraction required will need to be stronger, as there is a greater distance between the first magnet secured to the set of dentures and the second magnetic component.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

1. A denture attachment system for securing dentures in a mouth of a human patient for replacing one or more teeth with an artificial tooth(teeth), comprising:
a set of dentures comprising:
one or more teeth made out of a durable material;
a first magnetic component secured to or integrated into said set of dentures; and
a second magnetic component, physically spaced and separate from said first magnetic component but magnetically attracted thereto to retain said set of dentures within the human mouth of a patient, said second magnetic component being securable near said mouth by a means other than relying on support from a bone of the patient.

2. A denture attachment system as claimed in claim 1, wherein said second magnetic component is adapted to be implanted proximal to either the upper or lower jaw.

3. A denture attachment system as claimed in claim 1, wherein said second magnetic component is adapted to be secured to the patient by a piercing positioned in the lip, tongue, palatal arch, cheek, ear, nostril or nose of said patient.

4. A denture attachment system as claimed in claim 1, wherein said durable material is either ceramic or acrylic or a similar nonmagnetic material.

5. (canceled)

6. A method for providing dentures to a patient with resorbed mandibular ridges, the method comprising:
providing a set of physically and cosmetically appropriate dentures for the patient from a dental durable material, said dentures formed as a maxillary or mandible region; securing a first magnetic component thereto;
providing a second magnetic component, physically spaced and separate from said first magnetic component and said denture, said second magnetic component being secured near the mouth of a patient by a means other than relying on physical support from a bone of the patient; and
locating said second magnetic component on or about the mouth or face of the patient so that said second magnetic component is attracted to and retains said set of dentures by magnetic coupling to said first magnetic component.

7. A method as claimed in claim 6, wherein said set of dentures is made of ceramic, acrylic or a dental composite thereof.

8. A method as claimed in claim 6, wherein said first magnetic component is embedded within said set of dentures.

9. A method as claimed in claim 6 wherein said first magnetic component is secured to either a dental upper or lower set of dentures and said second magnetic component is secured to the nose, nostril, lip, ear, cheek, frenulums, palatal arch or proximal to the jaw.

10. A method as claimed in claim 6, wherein said second magnet is secured to the patient by having the same held within a nostril.
